(19) United States
(12) Patent Application Publication
(10) Pub. No.: US 2005/0217446 A1
(43) Pub. Date: Oct. 6, 2005

(54) Support table for a table saw

(75) Inventors: Kenneth M. Brazell, Piedmont, SC (US); Christopher J. Lewis, Anderson, SC (US)

Correspondence Address: BROOKS KUSHMAN P.C., 1000 TOWN CENTER, TWENTY-SECOND FLOOR, SOUTHFIELD, MI, 48075, US

(73) Assignee: One World Technologies Limited, Hamilton (BM)

(21) Appl. No.: 10/817,026

(22) Filed: Apr. 2, 2004

(51) Int. Cl. B25H 1/00; B26D 5/00; B26D 1/18; B27B 3/28; B23D 19/00; B27B 27/04

(52) U.S. Cl. 83/477.2; 144/286.5; 144/287

(57) ABSTRACT

An auxiliary support table is provided having a workpiece support surface and a pair of elongated arms sized to telescopically extend through spaced apart longitudinal channels formed in a table saw base. The elongated support arms are provided with a pair of pivot members on the distal ends thereof to secure the arms to the channels. The auxiliary support table is pivotal between an in use position and a stored position. In the in use position, the support table is generally parallel to the table saw top while in a stored position, the elongated arms telescope outward through the channels allowing the auxiliary support table to pivot downwardly to a generally perpendicular position relative to the table top.

### BACKGROUND OF THE INVENTION

1. Field of the Invention

This invention relates to out-feed support tables, particularly tables which are removably attachable to the rear edge of a table top woodworking tool such as a table saw or the like.

2. Background Art

When using woodworking tools which have a table top for supporting a workpiece such as a table saw, router table, band saw, or the like, it is frequently desirable to provide support for a long workpiece as it is being cut if the workpiece extends substantially beyond the out-feed side of the table top. Various floor mounted stands have been designed in the past having one or more rollers or a small planer support on the out-feed side of a table saw. Alternatively, extension tables have been utilized which attach to the power tool table top surface and extend in a coplanar manner beyond the out-feed side of the table as illustrated in U.S. Pat. No. 5,379,816. Auxiliary support tables of the prior art are either free standing, cantileveredly extending from the power tool, or attached to the power tool at one end and supported by legs at the other end. An example of a cantilevered out-feed table are shown in U.S. Pat. No. 4,640,326 (Hewitt) or U.S. Pat. No. 4,852,623 (Rodrigues).

Many table saws such as those illustrated in the Hewitt, Rodrigues and Charlton patents have a movable out-feed support surface which is located sufficiently rearward of the saw table so that the out-feed support table clears the saw motor when hinged downward to the vertical position when not in use.

It is desirable to have an out-feed support table for a power tool having a planar workpiece support surface which is removable or shiftable to an inactive position so that the power tool takes up minimum shop space. It is also desirable to have an out-feed support table which can be quickly and simply raised and lowered without having to adjust leg lengths in order to maintain the out-feed support table coplanar with the tool table.

### SUMMARY OF THE INVENTION

Accordingly, the table saw incorporating the present invention is made up of a saw base, a table top affixed to the saw base for supporting a workpiece, a motor drivingly connected to a rotary spindle oriented below the table top, rotatably driving a saw blade affixed to a spindle capable of extending partially through an opening formed in a table top to cut a workpiece placed thereon. The saw base and table top assembly further includes a pair of laterally spaced apart longitudinally extending channels having at least one guide member disposed adjacent an open end of each channel. An auxiliary support table is provided which slidably mounts to a saw base table top assembly. The auxiliary support table has a workpiece support surface and a pair of elongate arms which are sized to telescopically extend through the longitudinally extending channels. A pair of elongate arms, each having a pivot member are disposed at a distal end thereof to secure the arms to the channels. The auxiliary support table is adjustable between a use position with the elongate arms telescopically engaging the channels to position the workpiece support surface generally parallel to the saw table top. The auxiliary support table is shiftable to a stored position wherein the elongate arms telescope outwardly of the channels and pivot about the pivot members to position the workpiece support table orthogonal to the table top.

In a preferred embodiment of the invention, the motor is oriented relative to the saw base to extend beyond the rear side of the table top. In this embodiment, the auxiliary support table elongate arms extend sufficiently beyond the workpiece support surface so that when the auxiliary support table arms are telescoped outwardly through the channels the auxiliary support table hangs down the auxiliary support table from the rear edge of the table top.

Alternatively, the invention may be characterized as an out-feed support table for use with a table saw having a pair of longitudinally extending channels formed in the base table top assembly. The auxiliary out-feed support table having a workpiece support table has a generally planer upper support surface and a pair of elongate arms spaced apart and attached to an underside of the workpiece support table generally opposite the planer upper surface. The arms extend therefrom in spaced apart relation sized to telescopically extend into the pair of channels in the table saw base assembly. The distal end of each of the arms has a pivot member to temporarily secure the arms to the ends of the channels. The auxiliary support table is thereby adjustable between an in use position and a stored position. In the in use position, the elongate arms telescope inward through the channels to orient the workpiece support surface generally parallel to and aligned with the table saw top. In the stored position, the elongate arms telescope outwardly through the channels until the pivot member of the distal end of each arm engages the end of the channel allowing the auxiliary support table to rotate downwardly below and orthogonal to the table saw table top.

### BRIEF DESCRIPTION OF THE DRAWINGS

FIG. 1 illustrates a table saw incorporating the out-feed support table of the present invention with the out-feed support table in the in use position;

FIG. 2 is a table saw illustrating the out-feed support table in the stored position;

FIG. 3 illustrates a telescopic movement of the out-feed support table;

FIG. 4 illustrates the pivotal movement of the out-feed support table; and

FIG. 5 is an enlarged view illustrating the distal end of the out-feed support table arm and the open end of the channel.

### DETAILED DESCRIPTION OF THE PREFERRED EMBODIMENT(S)

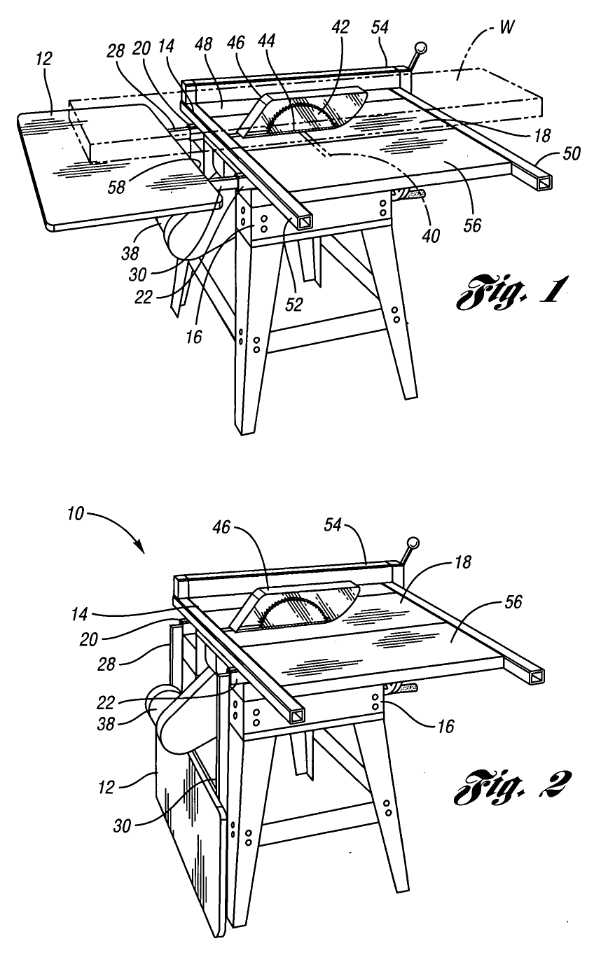

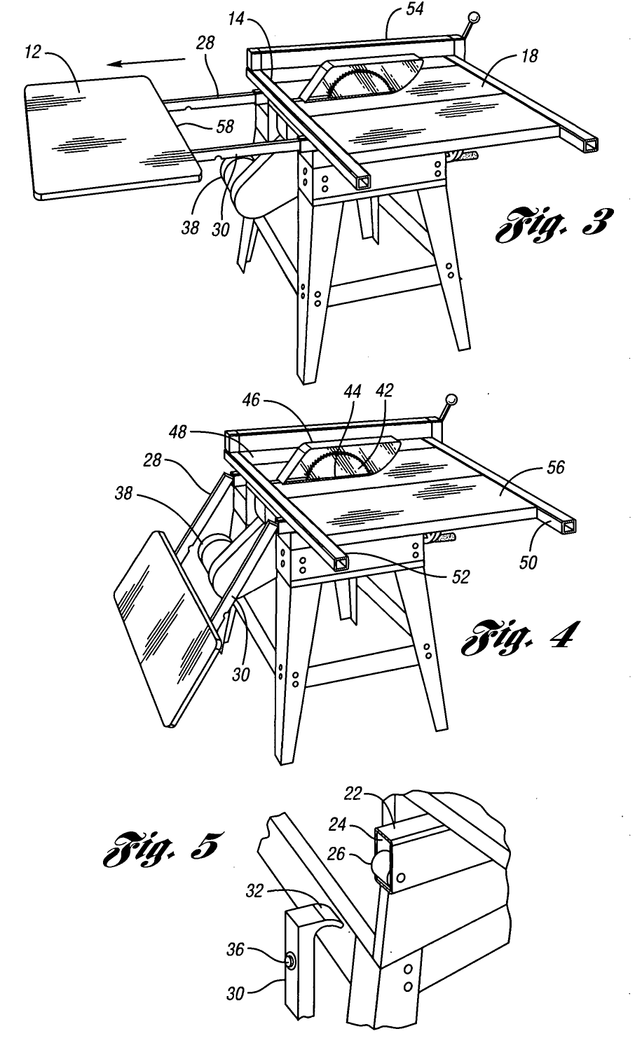

A table saw 10 illustrated in FIGS. 1-5 is provided with a novel out-feed support table 12. The out-feed support table 12 is located on the rearward side of the table saw in order to provide support for an elongated workpiece W as it extends beyond table top rear edge14 of table saw 10 as illustrated in FIG. 1. The out-feed support table 12 is designed to be easily moved between an in use position illustrated in FIG. 1 and a stored position illustrated in FIG. 2 in order to lower out-feed support 12, the user slides the out-feed support table in the direction of the arrow in FIG. 3. Once the out-feed support table 12 is at its maximum outward extent, it is free to downwardly pivot as illustrated in FIG. 4. The out-feed support table 12 can be easily installed and removed from the table saw unit 10 as illustrated in FIG. 5.

Table saw 10 is made up of a saw base 16 having a table top 18 affixed thereto which is provided with an upper surface for supporting workpiece W as illustrated in FIG. 1. The saw base and table top assembly is provided with a pair of laterally spaced apart longitudinally extending channels 20 and 22 spaced apart and having parallel orientation to one another as well as table top 18. Right and left channels 20 and 22 are preferably formed of a rectangular tubing as illustrated. However, other tubular profiles as well as a C-shaped channel can alternatively be used. Each of the channels 20 and 22 are provided with an open end 24 and a guide member 26. Guide member 26 as illustrated in FIG. 5 is provided by a cylindrical roller pivotally mounted adjacent the open end 24 of channel 22. Out-feed support table 12 is provided with a pair of elongate arms 28 and 30 sized to be telescopically received within corresponding to channels 20 and 22. The distal end of each of the arms 28 and 30 are provided with a pivot member 32 which in the preferred embodiment illustrated, is welded to arm 30. Pivot member 32 is sized to fit within open end 24 of channel 22. It is sufficiently large to catch on roller 26 which serves as a guide member. To install the out-feed support table 12 on table saw 10, a user simply hooks pivot members 32 of each of the support table arms into engagement with rollers 26 associated with the two channels 20 and 22. The operator will then rotate the out-feed support table upward to a generally planer orientation to the table saw table top 14 whereupon the out-feed support table can be moved toward the table saw causing the arms 28 and 30 to telescopically slide within channel 20 and 22. Preferably, a detent will be provided which serves to limit the telescopic movement of the arms relative to the channels. The detent can be provided by one or more pairs of indentations 34 formed on the underside of the arms 28 and 30. Indentations 34 cooperate with roller 26. The weight of table top 18 of the out-feed support table which is cantileveredly extended outward from the table saw causes the indentation of the detents 35 to engage roller 26 limiting telescopic movement of the arms relative to channels 20 and 22. In order to move the out-feed support table, the user simply lifts up slightly on table top 18 disengaging the indentation 34 from the roller allowing the arms 28 and 30 to telescopically move relative to channels 20 and 22. A single curve indentation may be supplied or alternatively, multiple pairs of indentations may be provided allowing the out-feed support table to be positioned at a plurality of locations.

An alternative form of detent can be provided limiting relative movement between arms 28 and 30 and channels 20 and 22 by simply forming a protrusion on the upper surface of arms 28 and 30 adjacent the distal end which cooperate with a indentation or aperture on the upper side of the channels. The protrusion on the arms can be provided by a simple adjustment screw 36 shown in FIG. 5. The adjustment screw cannot only serve to act as a detent once it slips under the small downwardly projected indentation in the upper channel surface, but, further acts as a method of adjusting the height and the planer alignment of the table top 18 of the out-feed support table 12 and table top 14 of table saw 10. Of course other well known detents could alternatively be used such as a spring loaded ball, flexible leaf spring latch or a cooperating castellations.

Table saw 10 is provided with a motor 38 which rotatably drives a spindle 40 shown in phantom outline in FIG. 1. Spindle 40 is located below table top 14 and operably drives a rotary saw blade 42. Saw blade 42 may be raised or lowered in a conventional manner so that it extends above the top work surface of table top 14 through elongate slot 44. Channels 20 and 22 are positioned on opposite sides of blade 42 in order to stably support out-feed support table 12 and workpiece W. Preferably, the table saw 10 will be provided with a blade guard 46 which generally surrounds the portion of blade 42 which projects above the upper surface of table top 14. Blade guard 46 is connected to a riving knife plate 48 in a conventional manner by pivots or links which allows blade guard 46 to rise up as workpiece W is fed into the saw blade 42. Preferably, the riving knife plate 48 and blade guard 46 tilt with saw blade 42 when the user adjusts the blade inclination relative to table top 14. When the user tilts the saw blade, frequently the riving knife as well as motor 38 move with the blade as the motor spindle blade assembly rotates about a trunion not shown. Typically, the riving knife plate 48 and the saw motor 38 will extend rearwardly beyond the rearward edge of saw table top 14. In the preferred embodiment illustrated, table saw 10 is provided with a front and rear rail 50 and 52, which define a forward and rearward edges of the table saw table top surface. Front and rear rails provide a convenient mounting for fence 54 for lateral extension table 56 which can be releasably affixed to the front and rear rails as the user selected a lateral position in order to support and guide the workpiece being cut. Channels 20 and 22 can alternatively be mounted to the base 16, saw table top 14 or front and rear rails 50 and 52. The nature of the structural attachment of the right and left channels to the table saw can vary depending upon tool designer's choice. The right and left channels can be designed to removably attach to existing conventional table saws allowing the out-feed support table of the present invention to be added to existing table saws at the time of manufacture or sold as an accessory.

Preferably, the table top 18 of out-feed support table is formed of a strong lightweight substrate such as particle board, plywood or royant strand board and covered with a low friction plastic laminate. Alternatively, the entire table top can be molded out of plastic and appropriately ribbed to achieve both product structure and lightweight. Preferably, the leading edge 58 of out-feed support table 12 is generally downwardly sloped relative to the remaining generally planer upper surface of out-feed support table top 18 in order to prevent the workpiece W from catching on the leading edge if a thin workpiece were to sag in instances where there is a gap between the leading edge 58 of the out-feed support table 12 and the rear rail 52 of the table saw. Of course, if desire, the out-feed support table top 18 can be sufficiently wide to minimize the gap between the leading edge 58 of the out-feed support table 12 and the rear rail 52. This gap, however, is preferable where as in the table top saw illustrated in FIG. 1, the motor extends rearwardly from the base 16 beyond rear rail 52. The out-feed support table and the arms are constructed of appropriate size and length so that the support table 12 can pivot downwardly as shown in FIG. 4 to the storage position without striking motor 38.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A table saw assembly comprising:
a saw base having a pair of laterally spaced apart, longitudinally extending channels including at least one guide member disposed adjacent an open end of the channel;
a motor and a spindle driven by the motor oriented within the saw base;
a table top affixed on the base for supporting a workpiece thereon;
a saw blade affixed to the spindle and driven thereby, the saw blade extending through an opening formed through the table top; and
an auxiliary support table slidably mounted to the saw base, the auxiliary support table having a workpiece support surface, a pair of elongate arms telescopically extending through the channels and a pair of pivot members disposed on a distal end of each arm to secure the arms in the channels,
wherein the auxiliary support table is adjustable between a use position wherein the elongate arms telescope inwardly through the channels to position the workpiece support surface generally parallel to the saw table top and a stored position wherein the elongate arms telescope outwardly through the channels and pivot about pivot members to position the workpiece support surface generally perpendicular to the table top.

2. The table saw assembly of claim 1 wherein the table top is provided with a forward edge corresponding to a side of the table top from which a work piece is fed into the saw blade and a rear edge corresponding to the work piece out-feed side of the table top, with the auxiliary support table oriented on the out-feed side of the table top to support a long work piece during cutting.

3. The table saw assembly of claim 1 wherein at least one guide member is formed by a roller.

4. The table saw assembly of claim 1 wherein the pair of pivot members are each formed by a hook located on the distal end of each of the elongate arms for limiting the movement of the auxiliary support table in the out-feed direction and suspending the auxiliary support table from the guide members when in the stored position.

5. The table saw assembly of claim 1 wherein the motor hangs off the back of the saw base, elongate arms long enough to allow the auxiliary table top to clear motor when moving to the stored position.

6. The table saw assembly of claim 1 wherein the leading edge of the auxiliary support table is downwardly sloped to prevent a long workpiece which is fed through the table saw from catching on the edge of the support table.

7. The table saw assembly of claim 1 wherein the auxiliary support table top surface is formed of a low friction plastic sheet laminated onto a substrate.

8. The table saw assembly of claim 1 wherein the saw base channels are tubular.

9. The table saw assembly of claim 8 wherein the saw base channels are rectangular in cross section.

10. The table saw assembly of claim 1 wherein at least one of the saw base channels and the associated auxiliary support table arm is provided with a detent to temporarily retain the auxiliary support table arm in the in use position.

11. The table saw assembly of claim 10 wherein the detent is formed by a projection on the upper surface of an elongate arm cooperating with a step formed in the interior upper surface of the of the channel.

12. The table saw assembly of claim 10 wherein the auxiliary support table detent is formed by a depression on the lower surface of an elongate arm cooperating with the channel guide member.

13. A table saw assembly comprising:
a saw base having a pair of laterally spaced apart, longitudinally extending channels each including a guide member disposed adjacent an open end of the channel;
a table top affixed on the base for supporting a workpiece thereon, the table top having a forward edge on an in-feed side and a rearward edge on a work piece out-feed side;
a motor mounted to the saw base and extending beyond the rear side of the table top;
a saw blade affixed to a spindle position beneath the table top and driven by the motor, the saw blade partially extending through an opening formed through the table top for cutting a workpiece positioned thereon; and
an auxiliary support table slidably mounted to the saw base, the auxiliary support table having a workpiece support surface, a pair of elongate arms telescopically extending through the channels and a pair of pivot members disposed on a distal end of each arm to temporarily secure the arms in the end of the channels,
wherein the auxiliary support table is adjustable between an in use position wherein the elongate arms telescope inwardly through the channels to orient the workpiece support surface generally parallel to and aligned with the rear edge of the saw table top, and a stored position wherein the elongate arms telescope outwardly through the channels and pivot about pivot members to hang the workpiece support surface of the auxiliary support table downwardly from the rear edge of the table top, below and inboard of the rearward most portion of the motor.

14. The table saw assembly of claim 13 wherein the table top is provided with a forward edge corresponding to a side of the table top from which a work piece is fed into the saw blade and a rear edge corresponding to the work piece out-feed side of the table top, with the auxiliary support table oriented on the out-feed side of the table top to support a long work piece during cutting.

15. The table saw assembly of claim 14 wherein the leading edge of the auxiliary support table is downwardly sloped to prevent a long workpiece which is fed through the table saw from catching on the edge of the support table.

16. The table saw assembly of claim 13 wherein the auxiliary support table top surface is formed of a low friction plastic sheet laminated onto a substrate.

17. The table saw assembly of claim 13 wherein at least one of the saw base channels and the associated auxiliary support table arm is provided with a detent to temporarily retain the auxiliary support table arm in the in use position.

18. An auxiliary out-feed support table for use with a table saw having saw base provided with a pair of laterally spaced apart, longitudinally extending channels each including a guide member disposed adjacent an open end of the channel, a table top affixed on the base for supporting a workpiece thereon, the table top having a forward edge on an in-feed side and a rearward edge on a work piece out-feed side, a motor mounted to the saw base and extending beyond the rear side of the table top, and a saw blade affixed to a spindle position beneath the table top and driven by the motor, the saw blade partially extending through an opening formed through the table top for cutting a workpiece positioned thereon, the auxiliary out feed support table comprising:
a workpiece support table having an generally planar upper surface;
a pair of elongate arms sized to telescopically extending into a pair of channels in a table saw, the distal end of each arm a pair having of pivot member to temporarily secure the arms in the end of the channels,
wherein the auxiliary support table is adjustable between an in use position wherein the elongate arms telescope inwardly through the channels to orient the workpiece support table upper surface generally parallel to and aligned with the saw table top, and a stored position wherein the elongate arms telescope outwardly through the channels and pivot about the guide members to hang the workpiece support table downwardly from the table saw table top, below and inboard of the rearward most portion of the table saw motor.

19. The auxiliary out-feed support table of claim 18 wherein at least one of the saw base channels and the associated auxiliary support table arm is provided with a detent to temporarily retain the auxiliary support table arm in the in use position.

20. The auxiliary out-feed support table of claim 18 wherein the leading edge of the auxiliary support table is downwardly sloped to prevent a long workpiece which is fed through the table saw from catching on the edge of the support table.
